(19) United States
(12) Patent Application Publication
(10) Pub. No.: US 2025/0083178 A1
(43) Pub. Date: Mar. 13, 2025

(54) NOVEL FLUID SUPPLY CUP

(71) Applicant: QINGDAO HANBO PLASTIC TECHNOLOGY CO., LTD., Qingdao, Shandong (CN)

(72) Inventor: Yun XIAO, Qingdao (CN)

(73) Assignee: QINGDAO HANBO PLASTIC TECHNOLOGY CO., LTD., Qingdao, Shandong (CN)

(21) Appl. No.: 18/726,910

(22) PCT Filed: Nov. 30, 2022
(86) PCT No.: PCT/CN2022/135430

§ 371 Date: Jul. 5, 2024

(30) Foreign Application Priority Data
Jan. 7, 2022 (CN) 202220042348.7
Apr. 2, 2022 (CN) 202210351645.4

(51) Int. Cl. B05C 11/10; B65D 77/22

(52) U.S. Cl. CPC B05C 11/1028; B65D 77/225

(57) ABSTRACT

A fluid supply cup, including a container. The container is arranged with an air-vent hole closed by a valve, a part of an edge of a side wall of the container surrounding a bottom extends downward to form a skirt for supporting the container; a corresponding position of the skirt corresponding to the air-vent hole is arranged with a corresponding gap, and a corresponding position of the valve and an edge of the skirt form a base for supporting the container. In the fluid supply cup, the base is formed by the gap cooperating with the corresponding position of the valve, preventing errors in an injection molding process from affecting normal placement of the fluid supply cup, and the valve can be quickly closed.

### FIELD

The present disclosure relates to fluid supply for paint-spraying guns, in particular to a novel fluid supply cup.

### BACKGROUND

When a liquid reservoir of a paint-spraying gun is connected with the paint-spraying gun to spray paint outwards, liquid inside a cup body continues to decrease, causing air pressure difference between inside and outside of the liquid reservoir of the paint-spraying gun to continue to increase, thereby causing the cup body to rupture under force and causing paint inside the cup body to outflow. An existing method for balancing the air-pressure difference between the inside and outside of the liquid reservoir of the paint-spraying gun is to set one air-vent hole through bottom or wall of the cup body, where the air-vent hole is detachably connected to a cover. When the cup body is turned upside down for painting, the cover is opened so that the air-vent hole can ventilate and constantly balance the air-pressure difference between the inside and outside of the cup body.

A Chinese invention patent with Pat. No. 200480041717.5 and an invention title of a fluid reservoir for a paint-spraying gun, and a Chinese invention patent with Pat. No. 201380039900.0 and an invention title of an exhaust assembly and a reservoir including the exhaust assembly, disclose air-vent methods which cannot visually observe an open state of the air-vent hole. When a user makes an operation mistake, the open state is observed by the user only after a large amount of paint in container leaks.

In view of the above-mentioned defects, a Chinese invention patent with Pat. No. 202111041366.X and an invention title of a fluid supply cup for a paint-spraying gun makes improvements. However, a skirt at a bottom is closed. In order to ensure that a blocking part can be opened smoothly, the air-vent hole must be kept far away from an inner wall of the skirt, and during an injection molding process, a mole-injection hole needs to be located at a center of the bottom, making it difficult to reasonably arrange the air-vent hole at a corresponding position at the bottom. It is necessary to precisely control an injection mold during production process, otherwise, problems such as blockage of the air-vent hole, flash on an inner wall of the air-vent hole, etc. occur, resulting in a problem of failure of normal air ventilation of the air-vent hole occurring.

Due to certain errors in the injection molding process, it is difficult for a height of a corresponding surface of the blocking part to be consistent with a height of an edge of the closed skirt. If the corresponding surface of the blocking part is too high, although it is convenient for the blocking part to close the air-vent hole smoothly in a vertical state of the cup body, when the cup body is placed vertically, weight of the whole cup body is concentrated on the corresponding surface of the blocking part, causing a problem of the cup body being placed unstable and even prone to overturning occurring. If the corresponding surface of the blocking part is too low, although stability of the vertical placement of the cup body is ensured, the blocking part cannot close the air-vent hole when the cup body is in the vertical state.

Moreover, the fluid supply cup, gravity cup, etc. are injection-molded thin-walled products. Due to limitation of a bottom space, a free end of the above-mentioned blocking part can only point to the center of the bottom during an opening process, and a distance between the free end and the bottom is small. A user holds the gun in one hand and can only open the free end with the other hand, and the opening process is not very smooth. When closing, the user can only press the free end with the other hand.

Therefore, the prior art needs to be further improved and developed.

### SUMMARY

According to the above-mentioned defects of the prior art, a purpose of the present disclosure is to provide a novel fluid supply cup to achieve the air ventilation of the bottom of the fluid supply cup, which is convenient for users to operate.

In order to solve the above-mentioned technical problems, the solutions of the present disclosure include:

A novel fluid supply cup, the novel fluid supply cup has a container, and the container is arranged with an air-vent hole closed by means of a valve, where a corresponding position of the valve facing a placement surface of a bottom of the container is as a support, and the support and a support structure of the bottom of the container form a base for supporting the container.

The novel fluid supply cup, where the support structure is at least two support feet or support columns evenly arranged at the bottom of the container, and support points of the support feet or the support columns are located at the same horizontal plane as the support to form the base.

The novel fluid supply cup, where the support structure is a special-shaped bottom, the special-shaped bottom includes a horizontal bottom and an inclined bottom, the valve is arranged close to the inclined bottom, and the horizontal bottom is at the same horizontal plane as the support to form the base.

The novel fluid supply cup, where the corresponding position is one of a plane, an inclined plane, a support foot, a support point, and a support edge arranged at the valve and facing the placement surface of the bottom of the container.

The novel fluid supply cup, where the valve is in a state of being detached from the air-vent hole, and the container is inclined to one side having the air-vent hole.

A novel fluid supply cup, the novel fluid supply cup has a container, and the container is arranged with an air-vent hole closed by means of a valve, where a part of an edge of a side wall of the container surrounding a bottom of the container extends downward to form a skirt for supporting the container, a corresponding position of the skirt corresponding to the air-vent hole is arranged with a corresponding gap, and a corresponding position of the valve and an edge of the skirt form a base for supporting the container.

The novel fluid supply cup, where the valve is in a state of being detached from the air-vent hole, and the container is inclined to one side having the gap.

The novel fluid supply cup, where the skirt includes a support edge and an inclined edge, the inclined edge is integrally connected with a corresponding end of the support edge, the support edge surrounds most of a circumference of the bottom of the container, the inclined edge surrounds remain of the circumference of the bottom of the container, the gap is located between two inclined edges, and the inclined edge extends from a direction of a connection position between the inclined edge and the support edge to the gap and a height gradually becomes shorter; when the valve is detached from the air-vent hole, the inclined edge is in contact with a placement surface of the container, and there is a space between the support edge and the placement surface of the container.

The novel fluid supply cup, where the skirt includes a support edge, the support edge surrounds a large part of a circumference of the bottom of the container, and remain of the circumference of the bottom of the container forms the gap; when the valve is detached from the air-vent hole, an end of the support edge is in contact with a placement surface of the container, and there is a space between the support edge and the placement surface of the container.

The novel fluid supply cup, where the valve is a flip-over valve, and a front end of a free end of the valve can protrude from the gap.

The novel fluid supply cup, where the bottom is circular, the air-vent hole is located on a center line of a sector, the gap is located at the sector, and the corresponding position of the valve is close to the gap.

The novel fluid supply cup, where the valve includes a valve housing arranged surrounding a periphery of the air-vent hole, and the valve housing is arranged with a rotatable closing element.

The novel fluid supply cup, where the corresponding position of the valve is an upper surface of the closing element or a highest position of the upper surface, and the upper surface of the closing element or the highest position of the upper surface is in the same horizontal plane as the edge of the skirt to form the base.

The novel fluid supply cup, where the corresponding position of the valve is an upper surface of the closing element or a highest position of the upper surface, at least two support surfaces are arranged at the edge of the skirt, and the upper surface of the closing element or the highest position of the upper surface is located in the same plane as the at least two support surfaces to form the base.

The novel fluid supply cup, where the closing element includes a basic base being able to be adapted to the valve housing, the basic base is connected with a blocking part, and a dowel pin of the blocking part is used for closing or opening the air-vent hole.

The present disclosure provides a novel fluid supply cup. By arranging a gap at a support skirt of the fluid supply cup, the gap corresponding to an air-vent hole, and a seat being formed by a cooperation of the gap and a corresponding part of a valve, normal placement of the fluid supply cup being influenced by errors during the injection molding process is avoided. For example, even if an upper surface of the valve is slightly lower than a height of an edge of the skirt, under an action of the gap, the cup body is slightly inclined towards the gap to apply pressure on the upper surface or the corresponding part of the valve, so that the valve can be quickly closed, thereby reducing shaking of the cup body when placed vertically, improving stability of the cup body when placed vertically, reducing control accuracy of production molds, and improving production efficiency. Moreover, by the free end of the valve protruding from the gap, during use, a user can find a protruding sharp corner to perform a “knock on” operation on an exposed part of the free end, so as to open the valve, thereby realizing air ventilation of the air-vent hole, without the need for operating by both hands. When closing, the user can find a protruding sharp corner to perform a “push against” operation on an exposed part of the free end, so as to close the valve, thereby realizing closure of the air-vent hole. Of course, the user can also hold the gun in one hand and perform the operation of opening or closing the valve with the other hand, which enriches the user's operation. Moreover, leverage force of the free end is more advantageous due to that the free end is exposed from the gap.

### BRIEF DESCRIPTION OF THE DRAWINGS

FIG. 1 is a schematic diagram of a sectional view of a container in the present disclosure.

FIG. 2 is a schematic diagram of a valve in an original state in the present disclosure.

FIG. 3 is a schematic diagram of a valve in an open state in the present disclosure.

FIG. 4 is a schematic diagram of a valve in a closed state in the present disclosure.

FIG. 5 is a schematic diagram of two supporting surfaces arranged in the present disclosure.

FIG. 6 is a schematic diagram of a closing element arranged laterally in the present disclosure.

FIG. 7 is a schematic diagram of another embodiment in the present disclosure.

FIG. 8 is a schematic diagram of a front view of a gap arranged of FIG. 7.

FIG. 9 is a schematic diagram of a sectional view of FIG. 7.

FIG. 10 is a schematic diagram of an embodiment of a large gap in the present disclosure.

FIG. 11 is a schematic diagram of a support-foot type in the present disclosure.

FIG. 12 is a schematic diagram of a special-shaped bottom in the present disclosure.

FIG. 13 is a schematic diagram of a plurality of wavy skirts in the present disclosure.

FIG. 14 is a schematic diagram of another wavy skirt in the present disclosure.

FIG. 15 is a schematic diagram of a first support of a valve in the present disclosure.

FIG. 16 is a schematic diagram of a second support of a valve in the present disclosure.

FIG. 17 is a schematic diagram of a third support of a valve in the present disclosure.

### DETAILED DESCRIPTION OF THE EMBODIMENTS

The present disclosure provides a novel fluid supply cup. In order to make the purposes, technical solutions, and effects of the present disclosure clearer and more definite, the following is given to further describe the present disclosure in detail. It should be understood that the specific embodiments described here are only used to explain the present disclosure and are not intended to limit the present disclosure.

The novel fluid supply cup provided by the present disclosure is a plastic thin-walled product, and its innovation lies in that a valve arranged at an air-vent hole is used as a support of the fluid supply cup to cooperate with a support structure at a bottom of the fluid supply cup, so as to realize a function of stable placement of the fluid supply cup. In order to cooperate with the valve as a support manner, the support structure at the bottom of the fluid supply cup can be implemented in various manners, and is not limited to the manners described below.

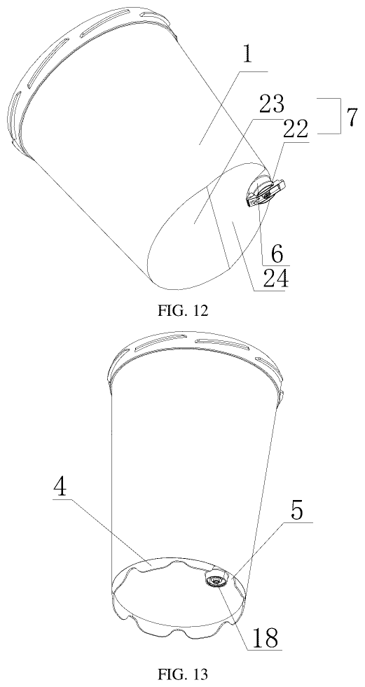

The above-mentioned fluid supply cup has a container 1, as shown in FIG. 11, FIG. 12, etc., the container 1 is arranged with an air-vent hole 18 closed by means of a valve 6, a corresponding position of the valve 6 facing a placement surface of a bottom of the container 1 is as a support 22, and the support and a support structure at the bottom of the container 1 form a base 7 for supporting the container 1. There are many supporting structures at the bottom of the container 1. For example, a plurality of supporting columns may be used, a special-shaped bottom may be used, and a skirt arranged at the bottom may be used.

Furthermore, the above-mentioned support structure is at least two support feet or support columns evenly arranged at the bottom of the container 1. Of course, three, four, or five support feet may be provided. In this embodiment, as shown in FIG. 11, two support feet 21 are arranged. A specific shape of the support foot 21 or the support column can be adjusted according to production needs, and is not repeated here. Support points of the support feet 21 or the support columns, and the support 22 are both located at the same horizontal plane to form the base 7.

In another preferred embodiment, the support structure is a special-shaped bottom. The special-shaped bottom includes a horizontal bottom 23 and an inclined bottom 24, and the horizontal bottom 23 and the inclined bottom 24 are connected together as an integral structure. The valve 6 is arranged close to the inclined bottom 24, and the horizontal bottom 23 and the support 22 are both located at the same horizontal plane to form the base 7. Of course, a ratio of an area of the horizontal bottom 23 to an area of the inclined bottom 24 may be adjusted according to specific needs, and is not repeated here.

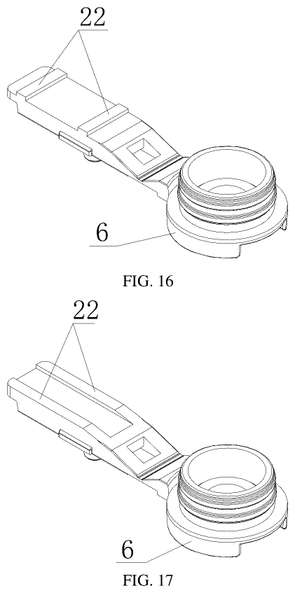

Furthermore, the above-mentioned corresponding position, i.e. the corresponding position of the valve 6 facing the placement surface of the bottom of the container 1, is one of a plane, an inclined plane, a support foot, a support point, and a support edge which are arranged at the valve 6 and face the placement surface of the bottom of the container 1. The corresponding position is generally arranged on a bottom surface of the valve 6, and its specific forms are shown in FIG. 15, FIG. 16, and FIG. 17, which are respectively a plane type, a support-foot type and a support-edge type. The plane support is generally adopted, cooperating with the above-mentioned support structure can further ensure the stability of the placement of the container 1.

In another preferred embodiment of the present disclosure, the support at the valve 6 cooperates with the support structure at the bottom of the container 1 to support the stable placement of the container 1. When the valve 6 is detached from the air-vent hole 18, i.e. when the above-mentioned valve 6 is in a state of separating from the air-vent hole 18, the container 1 is inclined to one side having the air-vent hole 18, that is to say, when the valve 6 is not installed on the air-vent hole 18, it can be seen clearly that the container 1 is in an inclined state, and an operator can clearly identify.

For the support structure at the bottom of the container 1, the present disclosure can also be implemented by arranging a skirt 4 at the bottom. More specific as follows.

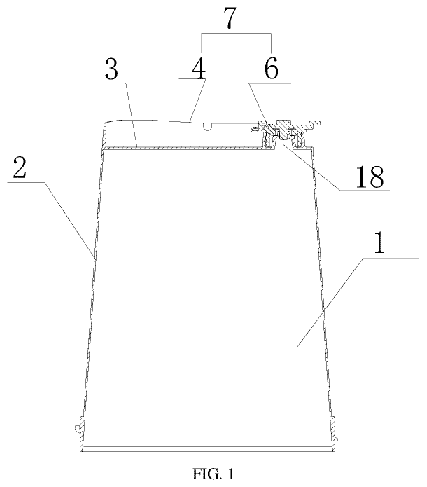

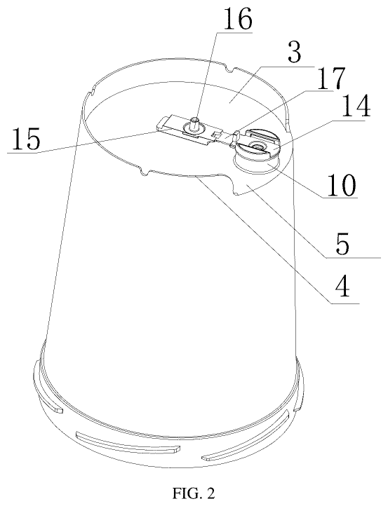

The present disclosure provides a novel fluid supply cup, as shown in FIG. 1 and FIG. 2. The fluid supply cup has a container 1, and the container is arranged with an air-vent hole 18 closed by means of a valve 6. A part of an edge of a side wall 2 of the container 1 surrounding a bottom 3 extends downward around to form a skirt 4 for supporting the container 1. Of course, the skirt 4 may also be implemented by a manner that adopting a plurality of vertical walls arranged in sequence or a space between two adjacent vertical walls. A corresponding position of the skirt 4 corresponding to the above-mentioned air-vent hole 18 is arranged with a corresponding gap 5. The gap 5 may be implemented by a manner that adopting a breach or an opening, and the gap 5 may also be implemented by reducing a height of the corresponding position of the skirt 4. Of course, a size and shape of the gap 5 may be set according to specific conditions of the bottom. The above-mentioned corresponding position of the valve 6 and an edge of the skirt 4 form a base 7 for supporting the container, that is to say, the above-mentioned corresponding position of the valve 6 is configured as a fulcrum for supporting the container 1, and cooperates with the edge of the skirt 4 or a relevant support point set on the edge to play a supporting role together. Generally, the above-mentioned corresponding position of the valve 6 means a bottom surface of the valve 6 facing the placement surface, or a highest position of the bottom surface, or an entire plane of the bottom surface. Even if the above-mentioned corresponding position of the valve 6 is slightly lower than the edge of the skirt 4, the cup body is slightly inclined towards the gap 5, due to the lack of one part of the gap 5, the above-mentioned corresponding position of the valve 6 is under stress to achieve closing of the valve 6. That is to say, even if there is an error in a relative dimension of the valve 6, the stability of the vertical placement of the container 1 can be guaranteed.

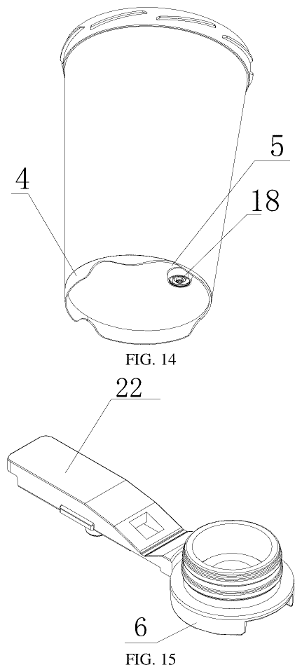

As shown in FIG. 13, the skirt 4 may be implemented in a manner that adopting a plurality of ripples, so that the skirt 4 forms a plurality of support points, and the plurality of the support points cooperates with the above-mentioned corresponding position of the valve 6 to form the above-mentioned base 7. As shown in FIG. 14, the skirt 4 may also be implemented in a manner that adopting two large ripples, so that the skirt 4 forms two support points, the two support points cooperate with the above-mentioned corresponding position of the valve 6 to form the above-mentioned base 7, and the gap 5 is formed at the air-vent hole 18 by reducing a height of the skirt 4. Of course, there are many manners to set the skirt 4, and are not repeated here.

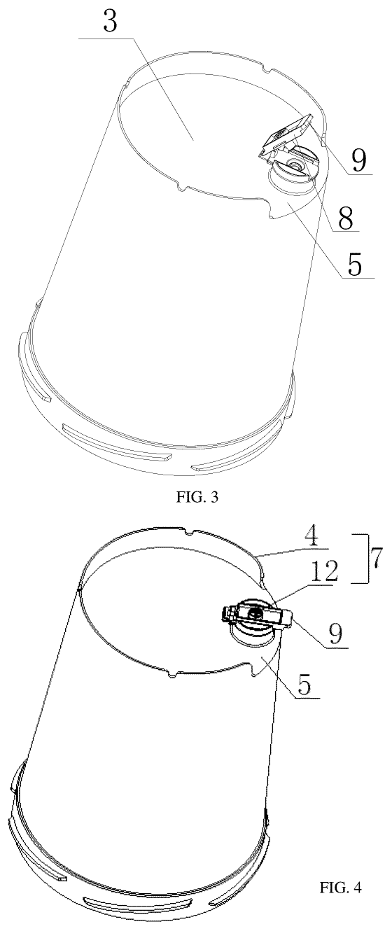

In another preferred embodiment of the present disclosure, as shown in FIG. 2 and FIG. 3, the valve 6 is a flip-over valve, and a front end 9 of a free end 8 of the valve 6 protrudes from the gap 5. Of course, the valve 6 may also be implemented in a manner that adopting a plug, and a surface of the plug facing the placement surface plays a supporting role. That is to say, by adopting a semi-closed skirt, the front end 9 can protrude from the gap 5, so that there is no need to precisely control a distance between the air-vent hole 18 and an interior of the skirt 4 during injection molding, thereby greatly improving the production efficiency of products. In addition, the valve 6 can be closed and opened by controlling the front end 9, that is to say, the operation of opening or closing the valve 6 by a single one hand holding the gun can be realized, which is convenient for a user to use. Generally, the closer the air-vent hole 18 is to the edge of the bottom of the container 1, the better the effect.

Furthermore, the above-mentioned bottom 3 is circular, the air-vent hole 18 is located at a center line of a sector where the above-mentioned gap 5 is located, and the corresponding position of the valve 6 is close to the gap 5. In a specific implementation process, the closer the air-vent hole 18 is to the gap 5 in a center of the sector, the closer the valve 6 is to the gap 5, the more obvious the support effect of the valve 6, and the more stable the container 1 is when placed vertically.

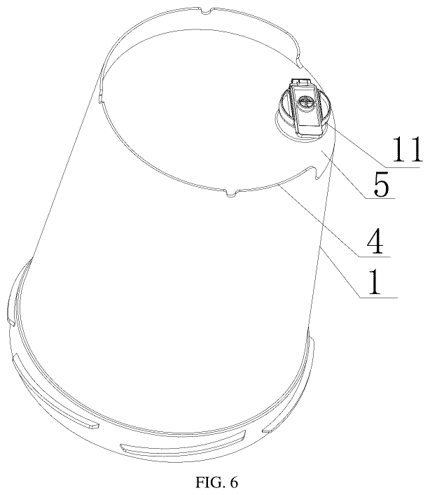

In another preferred embodiment of the present disclosure, as shown in FIG. 4 and FIG. 6, the valve 6 includes a valve housing 10 arranged around a periphery of the air-vent hole 18, and the valve housing 10 is arranged with a rotatable closing element 11. In specific use, the closing element 11 can be rotated so that the front end 9 of the free end 8 faces the gap 5, thereby realizing the above-mentioned related operation of opening or closing the valve. And after use, a user can turn the closing element 11 to a lateral position, as shown in FIG. 6, that is, place the free end 8 in a range of the bottom 3 to make the free end detach from the gap 5. When the container is placed vertically, the free end 8 does not protrude from the gap 5, so as to avoid a situation that the free end 8 is opened when the container 1 is placed vertically.

Various manners can be used for the base 7, for example, as shown in FIG. 4, and the above-mentioned corresponding position of the valve 6 is an upper surface of the closing element 11 or a highest position 12 of the upper surface. The upper surface of the closing element 11 or the highest position 12 of the upper surface is located at the same plane as the edge of the skirt 4, so as to form the above-mentioned base 7. This manner makes simple production and requires low precision for production molds.

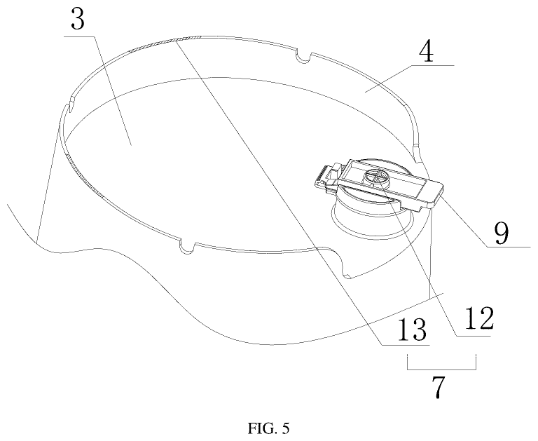

Another manner may also be used, the above-mentioned corresponding position of the valve 6 is an upper surface of the closing element 11 or a highest position 12 of the upper surface. As shown in FIG. 5, at least two support surfaces 13 are arranged on the edge of the skirt 4. In a more preferred manner, two support surfaces 13 arranged and the upper surface of the closing element 11 or the highest position 12 of the upper surface form a triangular base, improving the support stability, and further facilitating the control of processing dimensions. Of course, three or four support surfaces 13 may be provided, and not repeated here. The upper surface of the closing element 11 or the highest position 12 of the upper surface is at the same plane as the at least two support surfaces 13, so as to form the base 7.

Furthermore, as shown in FIG. 2 and FIG. 3, the closing element 11 includes a basic base 14 that can be adapted to the valve housing 10, the basic base 14 is connected with a blocking part 15, and a dowel pin 16 of the blocking part 15 is used to close or open the above-mentioned air-vent hole. One end of the blocking part 15 is hinged to one side of the basic base 14 by a connecting piece 17, a front portion of the blocking part 15 is the above-mentioned free end 8, and the front end 9 of the free end 8 can extend protrude from the gap 5. Of course, with the rotation of the closing element 11, the free end 8 is arranged laterally within the range of the bottom 3.

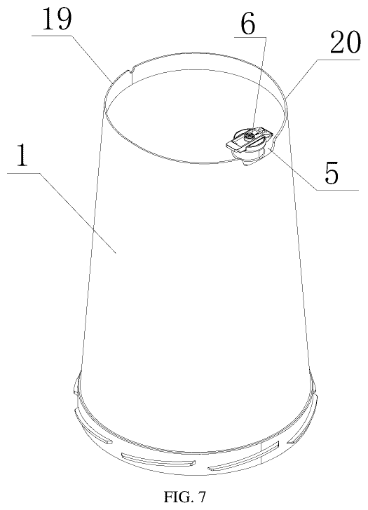

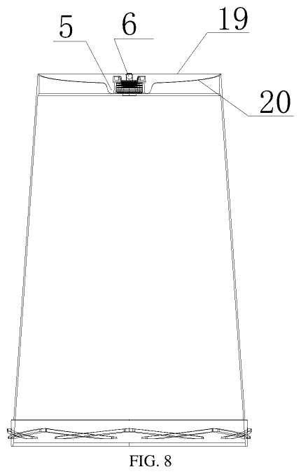

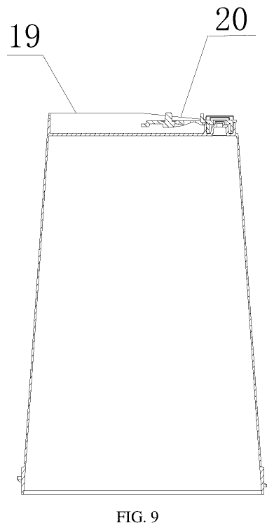

In another preferred embodiment of the present disclosure, as shown in FIG. 7, FIG. 8, and FIG. 9, the valve 6 is in a state of being detached from the air-vent hole 18, the container 1 is inclined to one side having the gap 5. That is to say, when the valve 6 is in a non-closed state, it can be clearly determined that the air-vent hole 18 is in an open state, and a user does not need to pour dye into the container 1, thereby avoiding occurring misoperation.

More optimally, the above-mentioned skirt 4 includes a support edge 19 and an inclined edge 20, and the inclined edge 20 is integrally connected with a corresponding end of the support edge 19. More specifically, the support edge 19 and the inclined edge 20 are integrally formed by injection molding, the support edge 19 surrounds most of a circumference of the bottom of the container 1, the inclined edge 20 surrounds remain of the circumference of the bottom of the container 1, and the above-mentioned gap 5 is located between two inclined edges 20. The inclined edge 20 extends from the direction of a connection position between the inclined edge and the support edge 19 to the gap 5 and a height gradually becomes shorter, i.e. gradual shortening. When the valve 6 is detached from the air-vent hole 18, the inclined edge 20 is in contact with the placement surface of the container 1. There is a space between the support edge 19 and the placement surface of the container 1, so that a purpose of the container 1 being inclined to one side having the gap 5 is realized. A user can clearly observe that the container 1 is in an inclined state, so as to the user from pouring dye into the container. When the valve 6 is inserted into the air-vent hole 18, a bottom of the valve 6 facing the placement surface of the container 1 and the support edge 19 form the above-mentioned base 7.

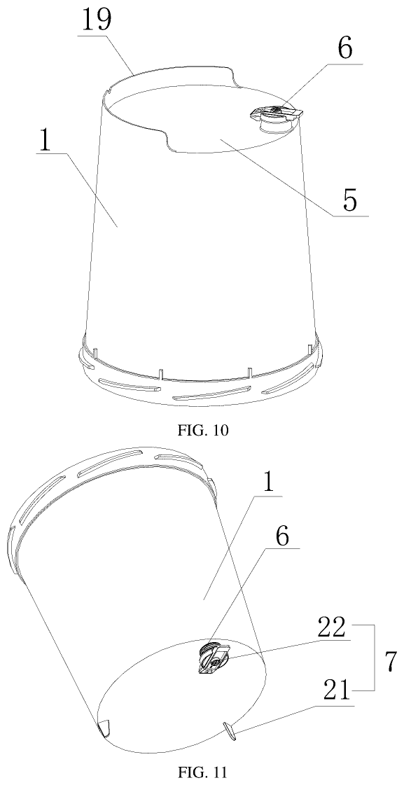

Another embodiment, according to specific settings of the gap 5, can be implemented by a breach or an opening. Of course, a size and shape of the gap 5 can be set according to a specific situation of the bottom. As shown in FIG. 10, the above-mentioned skirt 4 includes a support edge 19, the support edge 19 surrounds most of a circumference of the bottom of the container 1, remain of the circumference of the bottom of the container 1 forms the above-mentioned gap 5, and the size of the gap 5 is larger, so as to achieve the purposes of the present disclosure. When the valve 6 is detached from the air-vent hole 18, an end of the support edge 19 is in contact with the placement surface, and there is a space between the support edge 19 and the placement surface of the container 1. That is, a purpose of the container 1 being inclined to one side having the gap 5 is realized.

Of course, the above description is not intended to limit the present disclosure, and the present disclosure is not limited to the above embodiments. Changes, modifications, additions, or substitutions made by those skilled in the art within the essential scope of the present disclosure should belong to the protection scope of the present disclosure.

1-15. (canceled)

16. A fluid supply cup, the fluid supply cup comprising: a container, and the container being arranged with an air-vent hole closed by a valve, wherein a corresponding position of the valve facing a placement surface of a bottom of the container is as a support, and the support and a support structure of the bottom of the container form a base for supporting the container.

17. The fluid supply cup according to claim 16, wherein the support structure is at least two support feet or support columns evenly arranged at the bottom of the container, and support points of the support feet or the support columns are located at the same horizontal plane as the support to from the base.

18. The fluid supply cup according to claim 16, wherein the support structure is a special-shaped bottom, the special-shaped bottom comprises a horizontal bottom and an inclined bottom, the valve is arranged close to the inclined bottom, and the horizontal bottom is at the same horizontal plane as the support to form the base.

19. The fluid supply cup according to claim 16, wherein the corresponding position is one of a plane, an inclined plane, a support foot, a support point, and a support edge arranged at the valve and facing the placement surface of the bottom of the container.

20. The fluid supply cup according to claim 16, wherein the valve is in a state of being detached from the air-vent hole, and the container is inclined to one side having the air-vent hole.

21. A fluid supply cup, the fluid supply cup comprising: a container, and the container arranged with an air-vent hole closed by a valve, wherein a part of an edge of a side wall of the container surrounding a bottom of the container extends downward to form a skirt for supporting the container, a corresponding position of the skirt corresponding to the air-vent hole is arranged with a corresponding gap, and a corresponding position of the valve and an edge of the skirt form a base for supporting the container.

22. The fluid supply cup according to claim 21, wherein the valve is in a state of being detached from the air-vent hole, and the container is inclined to one side having the gap.

23. The fluid supply cup according to claim 21, wherein the skirt comprises a support edge and an inclined edge, the inclined edge is integrally connected with a corresponding end of the support edge, the support edge surrounds most of a circumference of the bottom of the container, the inclined edge surrounds remain of the circumference of the bottom of the container, the gap is located between two inclined edges, and the inclined edge extends from a direction of a connection position between the inclined edge and the support edge to the gap and a height gradually becomes shorter; when the valve is detached from the air-vent hole, the inclined edge is in contact with a placement surface of the container, and there is a space between the support edge and the placement surface of the container.

24. The fluid supply cup according to claim 21, wherein the skirt comprises a support edge, the support edge surrounds a large part of a circumference of the bottom of the container, and remain of the circumference of the bottom of the container forms the gap; when the valve is detached from the air-vent hole, an end of the support edge is in contact with a placement surface of the container, and there is a space between the support edge and the placement surface of the container.

25. The fluid supply cup according to claim 21, wherein the valve is a flip-over valve, and a front end of a free end of the valve can protrude from the gap.

26. The fluid supply cup according to claim 21, wherein the bottom is circular, the air-vent hole is located on a center line of a sector, the gap is located at the sector, and the corresponding position of the valve is close to the gap.

27. The fluid supply cup according to claim 21, wherein the valve comprises a valve housing arranged surrounding a periphery of the air-vent hole, and the valve housing is arranged with a rotatable closing element.

28. The fluid supply cup according to claim 27, wherein the corresponding position of the valve is an upper surface of the closing element or a highest position of the upper surface, and the upper surface of the closing element or the highest position of the upper surface is in the same horizontal plane as the edge of the skirt to form the base.

29. The fluid supply cup according to claim 27, wherein the corresponding position of the valve is an upper surface of the closing element or a highest position of the upper surface, at least two support surfaces are arranged at the edge of the skirt, and the upper surface of the closing element or the highest position of the upper surface is located in the same plane as the at least two support surfaces to form the base.

30. The fluid supply cup according to claim 27, wherein the closing element comprises a basic base being able to be adapted to the valve housing, the basic base is connected with a blocking part, and a dowel pin of the blocking part is used for closing or opening the air-vent hole.
